(19) United States
(12) Patent Application Publication
(10) Pub. No.: US 2014/0154366 A1
(43) Pub. Date: Jun. 5, 2014

(54) IMPREGNATION TYPE PUFFED FOOD AND METHOD FOR PRODUCING SAME

(71) Applicants: Takahiro Miura, Tsurugashima-shi (JP); Fumito Miya, Tsurugashima-shi (JP); Ayumi Hashiba, Tsurugashima-shi (JP); Masahiko Kurashige, Koto-ku (JP); Mitsunori Nozaka, Tsurugashima-shi (JP); Masakazu Nasu, Tsurugashima-shi (JP)

(72) Inventors: Takahiro Miura, Tsurugashima-shi (JP); Fumito Miya, Tsurugashima-shi (JP); Ayumi Hashiba, Tsurugashima-shi (JP); Masahiko Kurashige, Koto-ku (JP); Mitsunori Nozaka, Tsurugashima-shi (JP); Masakazu Nasu, Tsurugashima-shi (JP)

(73) Assignee: MEIJI CO., LTD., Tokyo (JP)

(21) Appl. No.: 14/118,036

(22) PCT Filed: May 25, 2012
(86) PCT No.: PCT/JP2012/063506

§ 371 Date: Feb. 3, 2014

(30) Foreign Application Priority Data
May 25, 2011 (JP) 2011-116555

(51) Int. Cl. A23G 3/54

(52) U.S. Cl. CPC A23G 3/54
USPC 426/103; 426/302

(57) ABSTRACT

The present invention provides an impregnation type puffed food in which an oil and fat confectionery material is impregnated into a food material to be impregnated, wherein the food material to be impregnated is a puffed confectionery having a surface thereof coated with a saccharide layer. Such an impregnation type puffed food has a novel texture, which is a “crunchy” hard texture combined with a texture of an oil and fat confectionery melting out of the inside.

### TECHNICAL FIELD

The present invention relates to an impregnated puffed food in which an oil and fat based confectionery material is impregnated into a puffed confectionery, and to a process for producing the same. Particularly, the present invention relates to a food in which an oil and fat based confectionery material is impregnated into the inner part of a puffed confectionery having a thick configuration and the surface thereof coated, and to a process for producing the same.

### BACKGROUND ART

Conventionally, various proposals have been made on foods in which a porous food is impregnated with a liquid food and processes of producing the same (Patent Literatures 1 to 3).

Products in which an oil and fat based confectionery material is impregnated into a porous food are commonly seen in markets. In particular, a wide variety of products of puffed confectionery impregnated with chocolate are available.

When the inner part of the chocolate-impregnated puffed confectionery products currently available in the market is observed, large area in the puffed confectioneries are not impregnated with chocolate. Most of these conventional products often have the maximum diameter of 25 to 30 mm and a thickness of about 10 mm, and a light “crispy” texture commonly found in snack foods. Although some puffed confectioneries have chocolate thoroughly impregnated to the center thereof, they have the maximum diameter of about 25 mm, a thickness of about 5 mm and a “crushing”, slightly hard distinctive texture.

### CITATION LIST

### Patent Literature

Patent Literature 1: International Publication No. WO 97/47207
Patent Literature 2: Japanese Patent Application Laid-Open No. 2004-254529
Patent Literature 3: International Publication No. WO 2010/114026
Patent Literature 4: Japanese Utility Model Registration No. 3118586

### SUMMARY OF INVENTION

### Technical Problem

The above Patent Literatures include many examples of the porous foods as the food to be impregnated. However, in the production on an actual industrial production line, it is difficult to impregnate chocolate into the inner part of a puffed confectionery produced by extruding and puffing with an applied pressure and heating. This is presumably caused by the comparatively smooth crust of the typical puffed confectioneries and additionally by voids separately present in the inner part of a puffed confectionery. Thus, to impregnate chocolate into the inner part of a puffed confectionery, the configuration in which cavities are formed in the center part to attain an enlarged surface area, or the configuration in which an enlarge easy-to-impregnate surface, namely, a large cross section, is formed by cutting an extruded and puffed confectionery thereby to thin the thickness of the hard-to-impregnate crust portion, is likely to be selected. For this reason, the conventional products have only limited texture dependently on the configuration thereof.

On the other hand, a chocolate-impregnated confectionery has been proposed which is obtained by opening a plurality of small pores in the puffed confectionery, immersing it in chocolate and applying a centrifugal force thereto to impregnate chocolate to evenly impregnate chocolate into the inner part of a puffed confectionery (Patent Literature 4). However, in a case where a puffed confectionery is brittle or small-sized, the puffed confectionery breaks when small pores are opened, thereby deteriorating the commercial product value as a food material.

An object of the present invention is to provide an impregnated puffed food into which an oil and fat based confectionery material is impregnated and which has an unprecedented novel texture, namely, an impregnated puffed food in which an oil and fat based confectionery material is impregnated into the inner part of a puffed confectionery having a brittle and easy-to-melt-in-mouse texture.

### Solution to Problem

To solve the problem, the present inventors studied intensively, and found that a confectionery, which is obtained by coating the surface of a puffed confectionery with a saccharide and then impregnating an oil and fat based confectionery material into the coated puffed confectionery, has a “crunchy” hard texture combined with a texture of an oil and fat based confectionery melting and spreading out of the inside. The present invention is based on this finding, and comprises the items described below.

(1) An impregnated puffed food in which an oil and fat based confectionery material is impregnated into a food material to be impregnated, wherein the food material to be impregnated is a puffed confectionery having a surface thereof coated with a saccharide layer.
(2) The impregnated puffed food according to (1), wherein the content of the oil and fat based confectionery material in the impregnated puffed food is 56 to 70% by weight.
(3) The impregnated puffed food according to (1) or (2), wherein the thickness between porous cross sections of the puffed food is 15 to 25 mm.
(4) The impregnated puffed food according to any one of (1) to (3), wherein the puffed confectionery contains 2.4 to 6.0% by weight of an edible oil and fat and 0.4 to 0.6% by weight of an emulsifier.
(5) The impregnated puffed food according to (4), wherein the emulsifier is a higher fatty acid monoglyceride having an HLB of 4.0 to 5.0 and/or a sucrose fatty acid ester having an HLB of 10 to 12.
(6) The impregnated puffed food according to (4) or (5), wherein the edible oil and fat is palm oil, palm kernel oil, shortening or a mixture thereof.
(7) The impregnated puffed food according to any one of (1) to (6), wherein the saccharide layer contains sucrose, maltose, lactose or a mixture thereof.
(8) The impregnated puffed food according to any one of (1) to (7), wherein the oil and fat based confectionery material has a viscosity at 34° C. of 3000 to 15000 cps.
(9) The impregnated puffed food according to any one of (1) to (8), wherein the oil and fat based confectionery material is a chocolate.
(10) A process for producing an impregnated puffed food comprising the steps of the following (a) to (c):

(a) discharging raw materials containing 40 to 80% by weight of wheat flower, 2.4 to 6.0% by weight of an edible oil and fat, and 0.4 to 0.6% by weight of an emulsifier using an extruder to obtain a puffed confectionery;

(b) spraying an aqueous solution containing at least one of sucrose, maltose and lactose to the puffed confectionery and subsequently drying to obtain a food material to be impregnated; and

(c) impregnating an oil and fat based confectionery material into the food material to be impregnated.

(11) The process according to (10), wherein the aqueous solution is an aqueous solution of 60 to 80% by weight of sucrose, an aqueous solution of 40 to 60% by weight of maltose, or an aqueous solution of 40 to 60% by weight of lactose.
(12) The process according to (10) or (11), wherein the step (c) comprises:

(c1) placing the food material to be impregnated in a hermetically closed container under a reduced pressure condition, coating with an oil and fat based confectionery material while maintaining the reduced pressure state, and then releasing the pressure to the atmospheric pressure.

(13) The process according to any one of (10) to (12), wherein the step (c) comprises:

(c1) placing the food material to be impregnated in a hermetically closed container under a reduced pressure condition, coating with an oil and fat based confectionery material while maintaining the reduced pressure state, and then releasing the pressure to the atmospheric pressure; and subsequently

(c2) placing the food material to be impregnated under a pressurized condition while maintaining the state in which the food material to be impregnated is coated with the oil and fat based confectionery material in the hermetically closed container, and then releasing the pressure to the atmospheric pressure.

(14) The process of production according to any one of (10) to (12), wherein the step (c) comprises:

(c1) placing the food material to be impregnated in a hermetically closed container under a reduced pressure condition, coating with an oil and fat based confectionery material while maintaining the reduced pressure state, and then releasing the pressure to the atmospheric pressure, and subsequently

(c3) placing the food material to be impregnated again under a reduced pressure condition while maintaining the state in which the food material to be impregnated is coated with the oil and fat based confectionery material in the hermetically closed container, and then releasing the pressure to the atmospheric pressure.

(15) An impregnated puffed food obtained by the process according to any one of (10) to (14).

### Advantageous Effects of Invention

By the present invention, it is possible to obtain a puffed food which is impregnated with an oil and fat based confectionery material and has an unprecedented novel texture, namely, a food in which an oil and fat based confectionery material is impregnated into the inner part of a puffed confectionery having a brittle and easy-to-melt-in-mouse texture.

### BRIEF DESCRIPTION OF DRAWINGS

FIG. 1 is a photograph showing a porous cross section of a puffed confectionery produced using raw materials containing 10 parts by weight of a milled product of cookies and 1.5 parts by weight of an edible oil and fat. (Example 1, Formulation 1-3)

FIG. 2 is a photograph showing a porous cross section of a puffed confectionery produced using raw materials containing 10 parts by weight of a milled product of cookies and 4.0 parts by weight of an edible oil and fat. (Example 1, Formulation 1-5)

FIG. 3 is a photograph showing a porous cross section of a puffed confectionery produced using raw materials containing 5.71% by weight of an edible oil and fat and 0.49% by weight of an emulsifier (HLB 4.1). (Example 2, Formulation 2-2)

FIG. 4 is a photograph showing a porous cross section of a puffed confectionery produced using raw materials containing 2.91% by weight of an edible oil and fat, 0.51% by weight of an emulsifier (HLB 4.1) and 0.01% by weight of an emulsifier (HLB 11). (Example 2, Formulation 2-6)

FIG. 5 is photographs showing the cross sections of the impregnated puffed food 0% by weight of the fine powder mixed therewith, produced by the impregnation step in which a pressure is reduced and then applied. (Example 5)

FIG. 6 is a photograph showing the cross sections of the impregnated puffed food having an amount of fine powder mixed of 5% by weight, produced by the impregnation step in which a pressure is reduced. (Example 5)

### DESCRIPTION OF EMBODIMENTS

For the purpose of providing the impregnated puffed food of the present embodiment, the inventors tried obtaining a puffed confectionery having the following properties: having the configuration with a thickness between porous cross sections of 15 mm or more, having an appearance of a large air-bubble size to enhance the efficiency for impregnating an oil and fat based confectionery material into the inner part thereof, and having a thin film thickness of the air-bubble to impart an easy-to-melt-in-mouth and brittle texture when crunched.

Such a puffed confectionery as above has a very brittle physical property and configuration. For this reason, when the puffed confectionery is fed to manufacturing machine to impregnate an oil and fat based confectionery material, micro cracks or chips are caused in the puffed confectionery and fine powders derived from the puffed confectionery mix into the oil and fat based confectionery material for the impregnation. When an amount of the above fine powder mixed in is increased, it prevents the oil and fat based confectionery material from being impregnated into the inner part of the puffed confectionery and hence the improvement was required. The foods in which a puffed confectionery is impregnated with an oil and fat based confectionery material had a unified texture of a puffed confectionery and an oil and fat based confectionery, which were favorable products, however, such a texture was not a quite novel texture.

Under the circumstances, the present inventors tried coating a puffed confectionery surface to inhibit the generation of fine powder while maintaining the texture and configuration of the puffed confectionery, and further to provide a novel texture. The surface coating is not a typically selected technique for impregnating an oil and fat based confectionery material into the inner part since it reduces the impregnation efficiency. Hereinafter, the impregnated puffed food of the present embodiments is described further in detail.

The puffed confectionery in the present embodiment is a food which has porous voids in the inner part, and particularly refers to puffed confectioneries cooked (cooked with heat) using an extruder to be puffed. More specifically, examples thereof include puffed snacks.

The puffed confectionery of the present embodiment preferably has the configuration which has a thickness. More specifically, the thickness between the porous cross sections is more preferably 15 to 25 mm, and further preferably 16 to 20 mm. The above porous cross section refers to a cross section which is formed when the dough discharged from an extruder to be puffed is cut. The configuration of porous cross section is not restricted and examples thereof include circular shapes, oval shapes, heart shapes, star shapes, triangle shapes, square shapes and other polygonal shapes. Coating the surface, as to be described later, of the puffed confectionery of the present embodiment inhibits the generation of fine powders during the impregnation step, and thus configurations having square porous cross sections, which are likely to be avoided in most cases, can be employed.

The puffed confectionery of the present embodiment has a texture of both softness to the teeth when crushed with teeth in the mouth, and easily falling-apart breakability when crunched. To attain such a texture, the tissue of puffed confectionery preferably has a large air-bubble size and a thin air-bubble film thickness. When a puffed confectionery made of the tissue having a large air-bubble size is obtained, the film of air-bubble usually becomes thick, likely causing a hard rough texture which is tough to teeth. When a puffed confectionery made of the tissue having a thin air-bubble film is obtained, the air-bubble becomes small, likely causing a texture which fails to provide a sense of breakability.

To achieve the texture described above, the puffed confectionery of the present embodiment preferably contains an edible oil and fat and an emulsifier in raw materials which contains wheat flour as the main component. More specifically, it is preferable to contain, with respect to raw materials containing 40 to 80% by weight of wheat flour, 2.4 to 6.0% by weight of an edible oil and fat and 0.4 to 0.6% by weight of an emulsifier.

Examples of the usable edible oil and fat include various vegetable oils and fats such as palm oil, palm kernel oil, rapeseed oil, coconut oil, peanut oil, safflower oil, sunflower oil, cottonseed oil, corn oil, soybean oil, rice oil and cocoa butter; various animal oils and fats such as beef tallow, lard, fish oil, whale oil and milk fat; and processed oils and fats obtained by subjecting these oils and fats to one or more treatments selected from hydrogenation, separation and ester exchange, and one or more selected from these can be used. In the puffed confectionery of the present embodiment, preferably palm oil, palm kernel oil, shortening or a mixture thereof, more preferably palm oil, shortening or a mixture thereof, and most preferably shortening is used.

Examples of the emulsifier include sucrose fatty acid esters, glycerol fatty acid esters, sorbitan fatty acid esters, higher fatty acid monoglyceride and lecitin. In the puffed confectionery of the present embodiment, as the emulsifier, preferably higher fatty acid monoglyceride or a mixture of higher fatty acid monoglyceride and sucrose fatty acid ester is used. With respect to the content of the above emulsifier, the puffed confectionery preferably contains 0.4 to 0.6% by weight of the higher fatty acid monoglyceride or 0.01 to 0.1% by weight of the sucrose fatty acid ester. The higher fatty acid monoglyceride preferably has an HLB of 4.0 to 5.0. The sucrose fatty acid ester preferably has an HLB of 10 to 12. Examples of the fatty acid of the emulsifier include stearic acid, oleic acid and palmitic acid, but are not limited to them insofar as the HLB falls within the above range.

The puffed confectionery of the present embodiment may contain usually employed raw materials in addition to the above-described wheat flour, edible oils and fats, and emulsifier. Examples thereof include grain flours such as rye flour, bread crumbs, whole wheat flour, cone flour, buckwheat flour and rice flour; saccharides such as sugar; and further, as a sub-raw material for adjusting a flavor or color tone, whole egg, egg white, dried whole egg, dried egg white, skimmed milk, dry milk, cocoa powder, flavors and dyes.

The puffed confectionery of the present embodiment is produced, for example, by the following process. Raw materials are fed into a feed opening of an extruder and allowed to be discharged from a nozzle opening at the tip of the extruder to obtain a puffed confectionery dough in the rope form. The operation conditions of the extruder may be suitably set in accordance with the equipment used, but, in a case where, for example, a twin-screw extruder (manufactured by Toshiba Machine Co., Ltd., TEM50B model) is used, an amount of water added is 2.5 to 4.0 kg/hr, the speed of screw revolution is 390 to 410 rpm, an inner pressure is 52 to 60 kgf/cm² and the material temperature is 167 to 170° C. The obtained puffed confectionery dough is cut into preferably 15 to 25 mm, more preferably 16 to 20 mm, and allowed to cool down until the product temperature reaches to room temperature, thereby obtaining a puffed confectionery.

The food material to be impregnated in the present embodiment refers to puffed confectionery whose surface is coated. Examples of the coating process specifically include a coating process using a saccharide, more specifically, a coating process using a candy solution, and a coating process in which saccharide crystals are adhered to the surface. The food material to be impregnated of the present embodiment is preferably a puffed confectionery in which the surface thereof is coated with saccharide crystals. By the above process, the distinctive crunchy hard texture, which is not achieved by a puffed confectionery alone, is imparted, and the generation of fine powders from the puffed confectionery, which causes a reduced efficiency in the subsequent impregnation step, can be inhibited.

Examples of the saccharide used in the coating process by which the saccharide crystals are adhered to the surface include sucrose, maltose, lactose and a mixture thereof. Sucrose is preferably used in the present embodiment as the above saccharide.

The food material to be impregnated in the present embodiment may be produced, for example, as follows. The saccharide used for the coating process is, in a case where sucrose is used, preferably a 60 to 80% by weight aqueous solution, and more preferably a 65 to 75% by weight aqueous solution, is used. In cases where maltose and lactose are used, preferably a 40 to 60% by weight aqueous solution, and more preferably 45 to 55% by weight aqueous solution, is used. The temperature of the above aqueous solution is 70 to 85° C. The puffed confectionery is fed into a coating drum heated to 60 to 80° C. and the above aqueous solution of saccharide (saccharide solution) is sprayed. The puffed confectionery gets the condition in which the saccharide solution is adhered throughout the entire surface thereof in the revolving coating drum. The puffed confectionery after the coating process is dried at 155 to 175° C. for 4 to 5 minutes to obtain a puffed confectionery (food material to be impregnated) provided with the saccharide layer on the surface thereof. The saccharide layer in the food material to be impregnated is preferably 12 to 18% by weight, and more preferably 13 to 16% by weight.

The impregnated puffed food of the present embodiment refers to those in which an oil and fat based confectionery material is impregnated into the food material to be impregnated.

The content of the oil and fat based confectionery material in the impregnated puffed food is preferably 56 to 70% by weight, and more preferably 58 to 65% by weight.

Examples of the oil and fat based confectionery material in the present embodiment specifically include edible oils and fats such as chocolate material, butter and margarine, and slurry and oil based cream which is obtained by dispersing a solid (sugar, cacao mass, dry milk, dried cheese, various spices, etc.) in the above oils and fats. A chocolate material is preferred to be the oil and fat based confectionery material in the present embodiment. The chocolate material refers to any chocolates which are fluent in the impregnation treatment step. The term chocolate in the present embodiment is not restricted by the “Fair Competition Code for Proper Labeling of Chocolate Products” certified by the Japan Fair Trade Commission. Namely, it is a food in which an edible component, such as a cocoa powder, saccharides or a finely-milled powder of milk solids, is suspended in a matrix consisting of a continuous layer of an edible oil and fat solidifying at a certain temperature or below, and optionally various emulsifiers, additives, flavors, etc. may be added. Typical examples include dark chocolate, milk chocolate and white chocolate.

The oil and fat based confectionery material of the present embodiment preferably has a viscosity at 34° C. of 3000 to 15000 cps, and more preferably 6000 to 10000 cps. In a case where an oil and fat based confectionery material having a high viscosity is used, an emulsifier is preferably added suitably to adjust the viscosity to the above range. The above viscosity refers to the viscosity measured with a single cylindrical rotating viscometer (Brookfield-type viscometer) using rotor No. 6 at a rotating speed of 4 rpm.

The impregnated puffed food of the present embodiment may be produced, for example, as follows. An oil and fat based confectionery material is prepared according to a conventional method. In a case where the oil and fat based confectionery material is a chocolate material, for example, raw materials composed of 21.0% by weight of cacao mass, 32.2% by weight of sugar, 10.0% by weight of dry milk, 7.5% by weight of cacao butter, 28.0% by weight of a vegetable oil and fat, 0.8% by weight of an emulsifier and 0.5% by weight of a flavor. The food material to be impregnated fed in a basket is placed in a hermetically closed container and the pressure is reduced to 0.008 MPa (which is in terms of the absolute pressure when the absolute vacuum is 0 MPa; the pressure hereinafter is the same), the above basket is put under the oil and fat based confectionery material kept at 35° C. while the state of reduced pressure is maintained. Subsequently, the pressure is gradually released to return to the atmospheric pressure, and the basket is taken out of the oil and fat based confectionery material. The food material to be impregnated obtained by the above treatment is taken out of the hermetically closed container, and the excess of the oil and fat based confectionery material adhered to the surface is removed by the centrifugal separation. The material is solidified under cooling at 15° C. to obtain an impregnated puffed food impregnated with the oil and fat based confectionery material (chocolate material). In this connection, the specific pressure in the reduced pressure state described above is an example, and an absolute pressure in the range of, for example, 0.005 to 0.07 MPa may be applicable.

The impregnated puffed food of the present embodiment may also be produced by the following process in which an additional step is added to the above process. The additional step is a step wherein the pressure is released from the reduced pressure state described above to return to the atmospheric pressure, then the pressure is increased to 0.3 MPa by feeding compressed air or the like to a space in the hermetically closed container while maintaining the state where the food material to be impregnated is in contact with the oil and fat based confectionery material and maintained for 0 to 20 seconds, and the pressure is released to return to the atmospheric pressure. According to the above production process in which the step of increasing pressure is added, the oil and fat based confectionery material after the treatment can be repeatedly used to carry out the same impregnation step. In this connection, the specific pressure in the step of increasing pressure described above is an example, and an absolute pressure in the range of, for example, 0.2 to 1 MPa may be applicable.

Alternatively, the additional step may be a step in which the pressure is released from the above-described reduced pressure state to return to the atmospheric pressure, the pressure is reduced again while maintaining the state where the basket is put into the oil and fat based confectionery material, and the pressure is gradually released to return to the atmospheric pressure.

The impregnated puffed food of the present embodiment may further be processed as needed by well-known methods such as an additional coating and topping.

By the present embodiment, the impregnated puffed food which has a novel texture combining a “crunchy” hard texture with a texture of an oil and fat based confectionery melting and spreading out of the inside and the process for producing the same can be provided. The impregnated puffed food of the present embodiment has a configuration with a thickness of 15 mm or more, and further has the structure in which the surface is coated with a saccharide, and yet the oil and fat based confectionery material is impregnated deeply into the inner part of the food material to be impregnated. In a case where an oil and fat based confectionery material having a low melting point is impregnated into the puffed confectionery of the present embodiment, the low melting point-oil and fat confectioneries, which are usually difficult to distribute during the summer time when the temperature is high, become available to taste in summer. According to the production process of the present embodiment, the cracks and chips caused when the oil and fat based confectionery material is impregnated into the puffed confectionery having brittle physical properties are inhibited by the saccharide layer applied to the puffed confectionery surface, and the impregnated puffed food having the intended quality can be produced while maintaining the impregnation efficiency of the oil and fat based confectionery material.

### EXAMPLES

The present invention will be described more specifically referring to the Examples, but the present invention is not restricted thereto.

### Example 1

### Studies on Formulation and Production of Puffed Confectionery (1)

To obtain a puffed confectionery having a soft, easily breakable texture, a puffed confectionery was produced using raw materials containing a milled product of cookies.

270 Parts by weight of sugar, 350 parts by weight of wheat flour, 140 parts by weight of shortening, 240 parts by weight of a whole egg and 1 part by weight of a flavor were mixed to obtain a cookie dough. The obtained cookie dough was formed into the sheet form, baked in an oven at 180° C. for 15 minutes to obtain cookies in the sheet form. The obtained cookies were milled to form a milled product of cookies.

The raw materials shown in Table 1 were fed into the feed opening of a twin-screw extruder (manufactured by Toshiba Machine Co., Ltd., TEM50B model), allowed to be discharged from a square nozzle opening in a size of about 9 mm×9 mm and located at the tip of the extruder to obtain a puffed confectionery dough in the rope form having a substantially square porous cross section. The operation conditions of the extruder are shown in Table 2. The obtained puffed confectionery dough was cut into a thickness of 16 to 20 mm, allowed to cool down until the product temperature reaches room temperature to obtain a substantially cubic puffed confectionery having a thickness of about 16 to 20 mm.

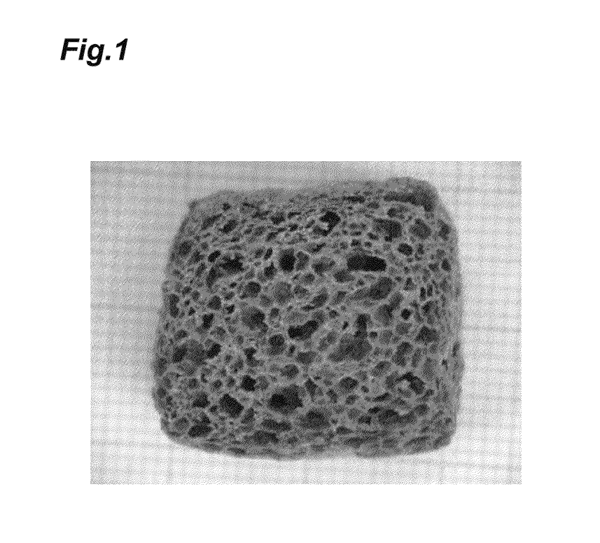

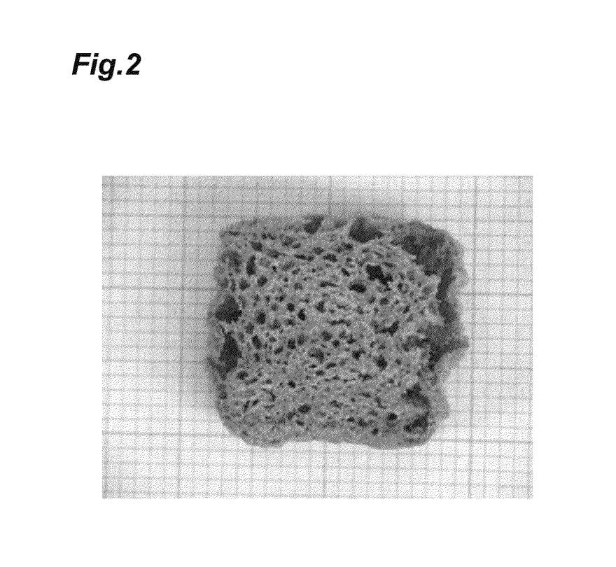

The obtained puffed confectionery was evaluated for texture (softness, breakability) and appearance of the porous cross section. The “softness” was rated as “S” for the particularly soft texture to the teeth when crushed with teeth in the mouth, “A” for the soft texture, “B” for the slightly hard texture, and “C” for the hard texture. The “breakability” was rated as “S” when the confectionery was brittle and easily breakable in the mouth, “A” when easily breakable, “B” when slightly hard to break, and “C” when hard to break. The agreeability of appearance of porous cross section was rated as “S” when the air-bubble size was large and the air-bubble film thickness was thin, “A” when the air-bubble size was slightly large and the air-bubble film thickness was slightly thin, “B” when the air-bubble size was slightly small and the air-bubble film thickness was slightly thick, and “C” when the air-bubble size was small and dense and the air-bubble film thickness was thick. The evaluation results are shown in Table 2. Photographs of the porous cross sections of Formulation 1-3 and Formulation 1-5 are respectively shown in FIG. 1 and FIG. 2.

TABLE 1

| | Formulation (part by weight) | | | | |
|---|---|---|---|---|---|
| | Formu- | Formu- | Formu- | Formu- | Formu- |
| | lation | lation | lation | lation | lation |
| | 1-1 | 1-2 | 1-3 | 1-4 | 1-5 |
| Wheat flour | 75.0 | 75.0 | 75.0 | 75.0 | 75.0 |
| Granulated sugar | 8.0 | 8.0 | 8.0 | 8.0 | 8.0 |
| Skimmed milk | 5.0 | 5.0 | 5.0 | 5.0 | 5.0 |
| Salt | 0.5 | 0.5 | 0.5 | 0.5 | 0.5 |
| Edible oil and fat | 1.0 | 1.0 | 1.5 | 2.0 | 4.0 |
| (purified palm oil) | | | | | |
| Emulsifler *Note 1 | 0.5 | 0.5 | 0.5 | 0.5 | 0.5 |
| Milled product of | — | 10.0 | 10.0 | 10.0 | 10.0 |
| cookies | | | | | |

*Note 1:
glyceryl monostearate (HLB 4.1)

TABLE 2

| | Formu- | Formu- | Formu- | Formu- | Formu- |
|---|---|---|---|---|---|
| Operation | lation | lation | lation | lation | lation |
| condition | 1-1 | 1-2 | 1-3 | 1-4 | 1-5 |
| Amount of water | 0.3 | 0.2 | 2.5 | 2.5 | 2.0 |
| added (kg/hr) | | | | | |
| Number of screw | 260 | 330 | 390 | 400 | 378 |
| revolutions (rpm) | | | | | |
| Inner pressure | 78 | 68 | 60 | 54 | 55 |
| (kgf/cm²) | | | | | |
| Material | 168 | 170 | 167 | 167 | 164 |
| temperature (° C.) | | | | | |
| Texture (softness) | C | B | A | B | C |
| Texture | C | C | A | B | C |
| (breakability) | | | | | |
| Porous cross | C | B | A | B | C |
| section appearance | | | | | |

Based on the results shown in Table 2, the puffed confectionery directly puffed using raw materials composed of wheat flour as the main component to which 10 parts by weight of the milled product of cookies and 1.5 to 2.0 parts by weight of the edible oil and fat were added had a soft and breakable texture (FIG. 1). Further, since the air-bubble size was large, the puffed confectionery had the preferable appearance for impregnating the oil and fat based confectionery material. When an amount of the edible oil and fat added exceeded 4.0 parts by weight, the puffing was insufficient which reduced the size, causing the small air-bubbles and a hard texture (FIG. 2).

### Example 2

### Studies on Formulation and Production of Puffed Confectionery (2)

For the purpose of obtaining a puffed confectionery having a soft, easily breakable texture equivalent to or more than the puffed confectionery obtained in Example 1, a large air-bubble size and the appearance in which the air-bubble film thickness is thin, a puffed confectionery was produced with a formulation containing the components contained in the milled product of cookies.

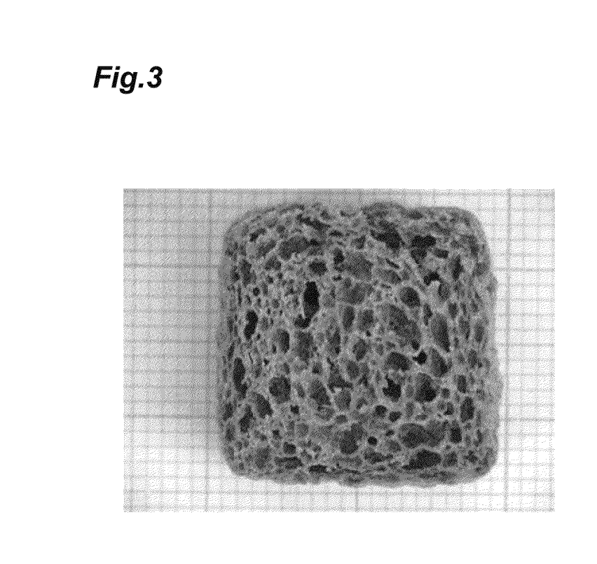

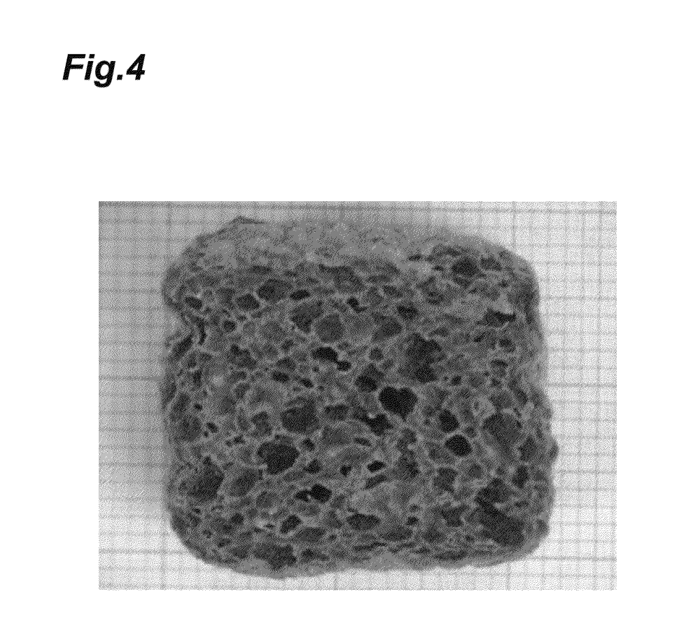

The raw materials shown in Table 3 were fed into a feed opening of a twin-screw extruder to produce a puffed confectionery in the same manner as in Example 1. However, the extruder operation conditions had an amount of water added of 3.8 kg/hr, the speed of screw revolutions of 410 rpm, an inner pressure of 52 kgf/cm² and a material temperature of 170° C. The obtained puffed confectionery was evaluated in the same manner as in Example 1. The results are shown in Table 3. Photographs of the porous cross sections of Formulation 2-2 and Formulation 2-6 are respectively shown in FIG. 3 and FIG. 4.

TABLE 3

| | Formulation (% by weight) | | | | | |
|---|---|---|---|---|---|---|
| | Formulation | Formulation | Formulation | Formulation | Formulation | Formulation |
| | 2-1 | 2-2 | 2-3 | 2-4 | 2-5 | 2-6 |
| Wheat flour | 76.74 | 76.01 | 75.88 | 79.89 | 79.69 | 79.49 |
| Granulated sugar | 11.78 | 11.66 | 11.65 | 10.88 | 10.85 | 10.83 |
| Skimmed milk | 4.91 | 4.86 | 4.85 | 5.09 | 5.08 | 5.07 |
| Salt | 0.49 | 0.49 | 0.49 | 0.54 | 0.54 | 0.54 |
| Edible oil and fat | | | | | | |
| purified palm oil | 4.81 | 5.71 | 5.71 | — | — | — |
| shortening | — | — | — | 2.44 | 2.68 | 2.91 |
| Emulsifier | | | | | | |
| glyceryl monostearate | 0.49 | 0.49 | 0.49 | 0.51 | 0.51 | 0.51 |
| (HLB 4.1) | | | | | | |
| sucrose fatty acid | — | — | — | 0.01 | 0.01 | 0.01 |
| ester (HLB 11) | | | | | | |
| Dried whole egg | 0.78 | 0.78 | 0.93 | 0.59 | 0.59 | 0.59 |
| Baking powder | — | — | — | 0.05 | 0.05 | 0.05 |
| Total | 100.00 | 100.00 | 100.00 | 100.00 | 100.00 | 100.00 |
| Texture (softness) | B | B | B | S | S | S |
| Texture (breakability) | A | S | A | S | S | S |
| Porous cross section | A | A | A | S | S | S |
| appearance | | | | | | |

Based on the results shown in Table 3, the puffed confectioneries prepared using raw materials composed of wheat flour as the main component to which 2.4 to 5.71% by weight of the edible oil and fat and 0.49 to 0.52% by weight of the emulsifier were added had a breakable texture and the appearance with a large air-bubble size and a thin air-bubble film thickness (FIG. 3, FIG. 4). Particularly, the puffed confectioneries produced using raw materials containing 2.4 to 2.91% by weight of shortening as the edible oil and fat, 0.51% by weight of glyceryl monostearate (HLB 4.1) and 0.01% by weight of sucrose fatty acid ester (HLB 11) as the emulsifiers had a soft, breakable texture and the appearance with a large air-bubble size and a thin air-bubble film thickness, providing good product qualities (FIG. 4).

### Test Example 1

### Production of Puffed Confectionery into which an Oil and Fat Based Confectionery Material is Impregnated

An oil and fat based confectionery material (chocolate material) was prepared by a conventional method using raw materials composed of 21.0% by weight of cacao mass, 32.2% by weight of sugar, 10.0% by weight of dry milk, 7.5% by weight of cacao butter, 28.0% by weight of a vegetable oil and fat, 0.8% by weight of an emulsifier and 0.5% by weight of a flavor. The puffed confectionery obtained with Formulation 2-6 in Example 2 was fed in a basket and placed in a hermetically closed container and the pressure was reduced to 0.008 MPa, the above basket was put under the chocolate material kept at 35° C. while the state of reduced pressure was maintained. Then, the pressure was gradually released to return to the atmospheric pressure and the basket was taken out of the chocolate material. The confectionery obtained by the above treatment was taken out of the hermetically closed container, and the excess of the chocolate material adhered to the surface was removed by the centrifugal separation. The confectionery was solidified under cooling at 15° C. to obtain a chocolate material impregnated-puffed food. The above obtained food had the chocolate material permeated into the inner part of the puffed confectionery, and had a unified texture of the chocolate and a puffed confectionery.

The chocolate material after treatment was repeatedly used for 2 to 3 times to produce the above food, and some foods did not have the chocolate material impregnated into the inner part of the puffed confectionery. When the chocolate material was observed, fine powders from the puffed confectionery were mixed in the chocolate material and increased the viscosity of the chocolate material from that before the treatment.

### Example 3

### Study on the Surface Coating Process of the Puffed Confectionery (Study on the Production of the Food Material to be Impregnated)

For the impregnated puffed food, the coating process of the surface of the puffed confectionery was studied for the purpose of providing, instead of the conventional unified texture, a novel texture which is well-balanced between both a crunchy hard texture derived from the puffed confectionery and a texture of chocolate melting and spreading out, and further inhibiting the generation of fine powders derived from the puffed confectionery during the impregnation step of the oil and fat based confectionery material.

The aqueous solutions of saccharide (saccharide solution) (80° C.) shown in Table 4 were prepared. The puffed confectionery was fed into a coating drum at 70° C. and the above saccharide solution was sprayed. The puffed confectionery, which had the saccharide solution adhered to all 6 surfaces of a substantially cubic configuration by the above treatment, was dried at 170° C. for 4 to 5 minutes to prepare a puffed confectionery (food material to be impregnated) having a surface coated with the saccharide layer.

The above obtained food material to be impregnated was evaluated for the surface conditions. For the surface conditions, those in which the saccharide graining was observed were rated as “A”, and those in which no graining was observed were rated as “C”. For the total evaluation, in addition to the evaluations on the surface conditions described above, sweetness (whether a sense of favorable sweetness was tasted) and texture (whether a sense of crunchiness was provided) are taken into consideration and those particularly preferable were rated as “S”, those preferable were rated as “A”, those slightly preferable were rated as “B”, and those not very preferable were rated as “C”. The results are shown in Table 4.

TABLE 4

| | Surface | Total | |
|---|---|---|---|
| Saccharide | condition | eval- | |
| (condition) | (graining) | uation | Remarks |
| Sucrose (70% by | A | S | Crunchy hard texture |
| weight solution) | | | |
| Maltose (50% by | A | B | Crispy texture, which was not |
| weight aqueous | | | much different from the texture |
| solution) | | | of a puffed confectionery itself. |
| | | | Sweetness was slightly light. |
| Lactose (50% by | A | B | Slightly yellowish appearance. |
| weight aqueous | | | Sweetness was slightly light. |
| solution) | | | |
| Sorbitol (70% by | C | C | |
| weight aqueous | | | |
| solution) | | | |

The results shown in Table 4 suggest that in a case where sucrose, maltose or lactose was used as the saccharide, the saccharide layer can be provided throughout the entire surface of the puffed confectionery. When sucrose was used, it was suggested that the puffed confectionery had both favorable sweetness and favorable texture, the crunchy hard texture was further imparted thereto, and sucrose was particularly preferable for producing the food material to be impregnated because the saccharide solubility is high and hence the saccharide solution during the production is easy to handle.

Of the food materials to be impregnated after the above treatment, about 3 to 3.5 kg of those having a surface thereof coated with sucrose was placed and sealed in a plastic bag, and enclosed in a box. The box was transported from Tokyo to Osaka using a delivery service, and when the box was opened, it was found that about 0 to 2 pieces of the food material to be impregnated had cracks or chips in the plastic bag. Before and after the transportation, a weight increase of the fine powder in the total weight was at most 0.7% only.

### Example 4

### Study on Impregnation Conditions of the Oil and Fat Based Confectionery Material into the Food Material to be Impregnated (1)

The production conditions were studied for impregnating the oil and fat based confectionery material (chocolate material) into the puffed confectionery (food material to be impregnated) having a surface thereof coated with the sucrose obtained in Example 3.

In the same manner as in Test Example 1, a chocolate material impregnated-puffed food was obtained. However, the impregnation production process was carried out under the following condition (condition 2) in addition to the process of Test Example 1 (condition 1). The food material to be impregnated was fed in a basket and placed in a hermetically closed container and the pressure was reduced to 0.008 MPa, the above basket was put under the chocolate material kept at 35° C. while the state of reduced pressure was maintained. Then, the pressure was gradually released to return to the atmospheric pressure. While the basket was kept under the chocolate material the pressure was increased to 0.3 MPa by feeding compressed air to a space in the hermetically closed container and maintained for 0 to 20 seconds. The pressure was gradually released to return to the atmospheric pressure, and the basket was taken out of the chocolate material. The obtained food material to be impregnated by the above treatment was taken out of the hermetically closed container, and the chocolate material adhered to the surface was removed by centrifugal separation. The material was solidified under cooling at 15° C. to obtain a chocolate material impregnated-puffed food.

All the impregnated puffed foods obtained by the above process had the chocolate material permeated into the inner part of the porous food material to be impregnated. Unlike those obtained in Test Example 1, the impregnated puffed food had a novel texture combining two different textures of both crunchy hard texture of puffed confectionery and a texture of chocolate gradually melting and spreading out.

### Example 5

### Study on Impregnation Conditions of the Oil and Fat Based Confectionery Material into the Food Material to be Impregnated (2)

Using a chocolate material in which fine powders prepared by milling a food material to be impregnated was mixed, an impregnated puffed food was produced in the same manner as in Example 4 for the evaluation, on the assumption that the food was continuously produced repeatedly using the chocolate material after the treatment.

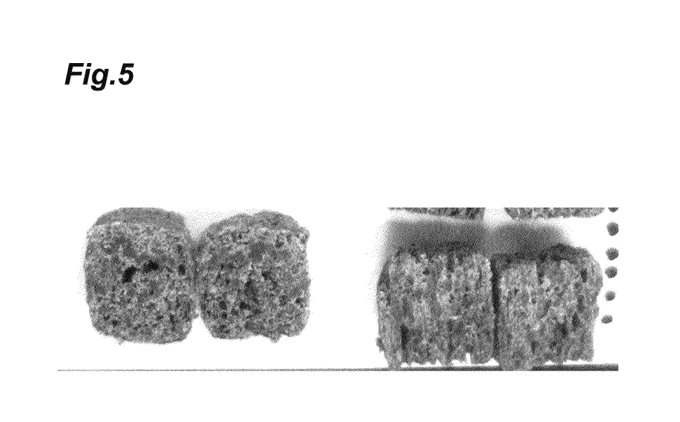

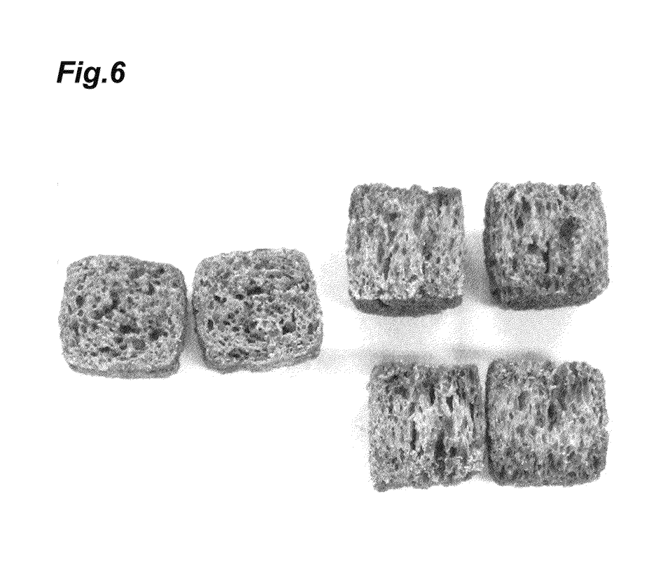

The puffed confectionery (food material to be impregnated) having the surface thereof coated with the sucrose obtained in Example 3 was milled to obtain a fine powder (particle size 1.5 mm pass). 0 to 5% by weight of the above fine powder was mixed with the chocolate material prepared in the same manner as in Test Example 1, and a chocolate material-impregnated puffed food was produced in accordance with condition 1 and condition 2 of Example 4. The obtained impregnated puffed food was cut in a direction perpendicular to and in a direction parallel to the porous cross section, and the inner part was observed to evaluate. The evaluation was performed as “A” when the chocolate material was impregnated into the center part, “B” when some parts close to the center in the puffed confectionery were left unimpregnated with the chocolate, and “C” when the chocolate adhered only to the surface part. The results are shown in Table 5. Further, the cut cross section of the impregnated puffed food having an amount of fine powder mixed of 0% by weight produced under condition 2 (inner part evaluation “A”) is shown in FIG. 5, and the cut cross section of the impregnated puffed food having an amount of fine powder mixed of 5% by weight produced under condition 1 (inner part evaluation “B”) is shown in FIG. 6.

TABLE 5

| | | | | | |
|---|---|---|---|---|---|
| Amount | | Pre- | | | |
| of fine | | treatment | Post- | Chocolate | |
| powder | Chocolate | puffed | treatment | weight in | Inner |
| mixed | material | confec- | impregnated | impregnated | part |
| (% by | viscosity | tionery | puffed food | puffed food | eval- |
| weight) | (cps) | weight (g) | weight (g) | (%) | uation |

Condition 1 (Reduced pressure only)

| | | | | | |
|---|---|---|---|---|---|
| 0 | 6250 | 17.3 | 43.1 | 59.9 | A |
| 3 | 6500 | 17.6 | 40.1 | 56.1 | B |
| 5 | 6500 | 16.8 | 39.0 | 56.9 | B |

Condition 2 (reduced pressure + applied pressure)

| | | | | | |
|---|---|---|---|---|---|
| 0 | 6250 | 17.0 | 48.6 | 65.0 | A |
| 3 | 6500 | 17.7 | 48.7 | 63.7 | A |
| 5 | 6500 | 17.6 | 50.9 | 65.4 | A |

Table 5 revealed that in a case where the amount of fine powder mixed was 0% by weight in the chocolate material, the chocolate material in any of the production conditions was impregnated into the center part of the food material to be impregnated (FIG. 5). In the impregnated puffed food obtained by impregnating the chocolate material only by the reduced pressure treatment (condition 1), it was suggested that the chocolate material was hardly impregnated into the inner part of the puffed confectionery as an amount of fine powder mixed increased (FIG. 6). On the other hand, in the impregnated puffed food obtained by the treatment in which the pressure was reduced and subsequently applied (condition 2), it was suggested that the good quality impregnated puffed food into which chocolate was impregnated to the inner part of the puffed confectionery can be obtained even when the amount of fine powder mixed increased to 5% by weight.

### Example 6

### Study on Impregnation Conditions of the Oil and Fat Based Confectionery Material into the Food Material to be Impregnated (3)

The production conditions were further studied for impregnating the oil and fat based confectionery material (chocolate material) into the puffed confectionery (food material to be impregnated) having a surface thereof coated with the sucrose obtained in Example 3. The chocolate material prepared in Test Example 1 was used.

The impregnation production process was carried out under the following conditions (condition 3). The food material to be impregnated was fed in a basket and placed in a hermetically closed container, the pressure was reduced to 6 kPa, and the above basket was put under the chocolate material kept at 32 to 33° C. while the state of reduced pressure was maintained. Then, the pressure was gradually released to return to the atmospheric pressure. The pressure was reduced again to 6 kPa while the basket was kept under the chocolate material. The pressure was gradually released to return to the atmospheric pressure, and the basket was taken out of the chocolate material. The food material obtained by the above treatment was taken out of the hermetically closed container, and the chocolate material adhered to the surface was removed by centrifugal separation. The material was solidified under cooling at 15° C. to obtain a chocolate material impregnated-puffed food.

The impregnated puffed foods obtained by the above process had the chocolate material permeated into the inner part of the porous food material to be impregnated. The texture was a novel texture combining two different textures of both crunchy hard texture of the puffed confectionery and a texture of chocolate gradually melting and spreading out.

1. An impregnated puffed food in which an oil and fat based confectionery material is impregnated into a food material to be impregnated, wherein the food material to be impregnated is a puffed confectionery having a surface thereof coated with a saccharide layer.

2. The impregnated puffed food according to claim 1, wherein a content of the oil and fat based confectionery material in the impregnated puffed food is 56 to 70% by weight.

3. The impregnated puffed food according to claim 1, wherein a thickness between porous cross sections of the puffed food is 15 to 25 mm.

4. The impregnated puffed food according to claim 1, wherein the puffed confectionery contains 2.4 to 6.0% by weight of an edible oil and fat and 0.4 to 0.6% by weight of an emulsifier.

5. The impregnated puffed food according to claim 4, wherein the emulsifier is a higher fatty acid monoglyceride having an HLB of 4.0 to 5.0 and/or a sucrose fatty acid ester having an HLB of 10 to 12.

6. The impregnated puffed food according to claim 4, wherein the edible oil and fat is palm oil, palm kernel oil, shortening or a mixture thereof.

7. The impregnated puffed food according to claim 1, wherein the saccharide layer contains sucrose, maltose, lactose or a mixture thereof.

8. The impregnated puffed food according to claim 1, wherein the oil and fat based confectionery material has a viscosity at 34° C. of 3000 to 15000 cps.

9. (canceled)

10. A process for producing an impregnated puffed food comprising the steps of the following (a) to (c):
(a) discharging raw materials containing 40 to 80% by weight of wheat flour, 2.4 to 6.0% by weight of an edible oil and fat, and 0.4 to 0.6% by weight of an emulsifier using an extruder to obtain a puffed confectionery;
(b) spraying an aqueous solution containing at least one of sucrose, maltose and lactose to the puffed confectionery and subsequently drying to obtain a food material to be impregnated; and
(c) impregnating an oil and fat based confectionery material into the food material to be impregnated.

11. The process according to claim 10, wherein the aqueous solution is an aqueous solution of 60 to 80% by weight of sucrose, an aqueous solution of 40 to 60% by weight of maltose, or an aqueous solution of 40 to 60% by weight of lactose.

12. The process according to claim 10, wherein the step (c) comprises:
(c1) placing the food material to be impregnated in a hermetically closed container under a reduced pressure condition, coating with an oil and fat based confectionery material while maintaining the reduced pressure state, and then releasing the pressure to the atmospheric pressure.

13. The process according to claim 10, wherein the step (c) comprises:
(c1) placing the food material to be impregnated in a hermetically closed container under a reduced pressure condition, coating with an oil and fat based confectionery material while maintaining the reduced pressure state, and then releasing the pressure to the atmospheric pressure; and subsequently
(c2) placing the food material to be impregnated under a pressurized condition while maintaining the state in which the food material to be impregnated is coated with the oil and fat based confectionery material in the hermetically closed container, and then releasing the pressure to the atmospheric pressure.

14. The process according to claim 10, wherein the step (c) comprises:
(c1) placing the food material to be impregnated in a hermetically closed container under a reduced pressure condition, coating with an oil and fat based confectionery material while maintaining the reduced pressure state, and then releasing the pressure to the atmospheric pressure, and subsequently
(c3) placing the food material to be impregnated again under a reduced pressure condition while maintaining the state in which the food material to be impregnated is coated with the oil and fat based confectionery material in the hermetically closed container, and then returning the pressure to the atmospheric pressure.

15. An impregnated puffed food obtained by the process according to claim 10.

16. The impregnated puffed food according to claim 2, wherein a thickness between porous cross sections of the puffed food is 15 to 25 mm.

17. The impregnated puffed food according to claim 1,
(i) wherein the content of the oil and fat based confectionery material in the impregnated puffed food is 56 to 70% by weight,
(ii) wherein the thickness between porous cross sections of the puffed food is 15 to 25 mm,
(iii) wherein the puffed confectionery contains 2.4 to 6.0% by weight of an edible oil and fat and 0.4 to 0.6% by weight of an emulsifier,
(iv) wherein the emulsifier is a higher fatty acid monoglyceride having an HLB of 4.0 to 5.0 and/or a sucrose fatty acid ester having an HLB of 10 to 12,
(v) wherein the edible oil and fat is palm oil, palm kernel oil, shortening or a mixture thereof,
(vi) wherein the saccharide layer contains sucrose, maltose, lactose or a mixture thereof,
(vii) wherein the oil and fat based confectionery material has a viscosity at 34° C. of 3000 to 15000 cps.

18. An impregnated puffed food obtained by the process according to claim 11.

19. An impregnated puffed food obtained by the process according to claim 12.

20. An impregnated puffed food obtained by the process according to claim claim 13.

21. An impregnated puffed food obtained by the process according to claim claim 14.
